(19) United States
(12) Patent Application Publication
(10) Pub. No.: US 2026/0261318 A1
(43) Pub. Date: Sep. 3, 2026

(54) CODEBOOK-BASED PUSCH TRANSMISSIONS USING THE EIGHT ANTENNA PORTS AND UP TO EIGHT TRANSMISSION LAYERS

(71) Applicant: Intel Corporation, Santa Clara, CA (US)

(72) Inventors: Guotong Wang, Beijing (CN); Bishwarup Mondal, San Ramon, CA (US); Viktor Sergeev, Lucan, Dublin (IE)

(21) Appl. No.: 19/151,168

(22) PCT Filed: Feb. 7, 2024
(86) PCT No.: PCT/US2024/014764

§ 371 Date: Jul. 25, 2025

Related U.S. Application Data
(60) Provisional application No. 63/487,534, filed on Feb. 28, 2023.

(30) Foreign Application Priority Data
Mar. 30, 2023 (WO) PCT/CN2023/084994
Mar. 31, 2023 (WO) PCT/CN2023/085464

(51) Int. Cl. H04B 7/06; H04W 72/21

(52) U.S. Cl. CPC H04B 7/0639; H04W 72/21

(57) ABSTRACT

A user equipment (UE) configured for operation in a fifth-generation new radio (5G NR) network may be configured with a codebook type for a codebook-based physical uplink shared channel (PUSCH) transmission with eight antenna ports and up to eight transmission layers. The codebook type may have a coherency indication which may indicate one of a fully coherent codebook 2024/182102 type, a partially coherent codebook type and a non-coherent codebook type. A downlink control information (DCI) format scheduling the codebook—based PUSCH transmission with the eight antenna ports may indicate a transmit precoding matrix indicator (TPMI) index and a number of transmission layers for the PUSCH transmission. The UE may generate a precoding matrix (W) based on the TPMI index and the codebook type and encode a PUSCH for the codebook-based PUSCH transmission with the eight antenna ports and the indicated number of transmission layers by applying the generated precoding matrix. The precoding matrix (W) use a codebook based on the coherency indication. A restriction on codebook parameters may be applied for the fully coherent codebook type.

### PRIORITY CLAIMS

This application claims the benefit of priority to United States Provisional Patent Application Ser. No. 63/487,534, filed Feb. 28, 2023 [reference number AF2201-Z], International Application No. PCT/CN 2023/084994, filed Mar. 30, 2023 [reference number AF2677-PCT-Z], and International Application No. PCT/CN2023/085464, filed Mar. 31, 2023 [reference number AF2693-PCT-Z], all of which are incorporated herein by reference in their entireties.

### TECHNICAL FIELD

Embodiments pertain to wireless communications.

### BACKGROUND

Mobile communications have evolved significantly from early voice systems to today's highly sophisticated integrated communication platform. With the increase in different types of devices communicating with various network devices, usage of 3GPP 5G NR systems has increased. The penetration of mobile devices (user equipment or UEs) in modern society has continued to drive demand for a wide variety of networked devices in many disparate environments. 5G NR wireless systems are forthcoming and are expected to enable even greater speed, connectivity, and usability, and are expected to increase throughput, coverage, and robustness and reduce latency and operational and capital expenditures. 5G NR networks will continue to evolve based on 3GPP LTE-Advanced with additional potential new radio access technologies (RATs) to enrich people's lives with seamless wireless connectivity solutions delivering fast, rich content and services. As current cellular network frequency is saturated, higher frequencies, such as millimeter wave (mm Wave) frequency, can be beneficial due to their high bandwidth.

Current version of 5G NR allow for codebook based transmissions with up to four antenna ports and up to four transmission layers. To improve throughput, future versions of 5G NR would like to use up to eight antenna ports with up to eight transmission layers for codebook-based transmissions. One issue with codebook-based transmissions that use eight antenna ports with up to eight transmission layers is the codebook complexity. Designing an optimal codebook that covers all possible channel scenarios becomes very complex as the number of antennas and layers increases. There is an exponential increase in possible precoding matrices that need to be included in the codebook. Furthermore, to support more antennas and layers, the codebook size increases exponentially, which requires more bits for the UE to feedback the preferred precoding matrix indicator (PMI) which increases uplink overhead.

Thus, what is needed are techniques to reduce complexity for codebook-based transmissions that use coherent precoding for eight antenna ports with up to eight transmission layers.

### BRIEF DESCRIPTION OF THE DRAWINGS

FIG. 1A illustrates an architecture of a network, in accordance with some embodiments.

FIG. 1B and FIG. 1C illustrate a non-roaming 5G system architecture in accordance with some embodiments.

FIG. 2 illustrates a functional block diagram of a wireless communication device, in accordance with some embodiments.

FIG. 3 illustrates a multi-antenna port transmission with multiple transmission layers, in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

Some embodiments are directed to a user equipment (UE) configured for operation in a fifth-generation new radio (5G NR) network. The UE may decode a radio-resource control (RRC) information element (IE) received from a gNode B (gNB) to configure the UE with a codebook type for a codebook-based physical uplink shared channel (PUSCH) transmission with eight antenna ports and up to eight transmission layers. In these embodiments, the codebook type may have a coherency indication which may indicate one of a fully coherent codebook type, a partially coherent codebook type and a non-coherent codebook type. In these embodiments, the UE may decode a downlink control information (DCI) format scheduling the codebook-based PUSCH transmission with the eight antenna ports. In these embodiments, the DCI format may indicate a transmit precoding matrix indicator (TPMI) index and a number of transmission layers for the PUSCH transmission. The UE may generate a precoding matrix (W) based on the TPMI index and the codebook type and encode a PUSCH for the codebook-based PUSCH transmission with the eight antenna ports and the indicated number of transmission layers by applying the generated precoding matrix. In these embodiments, to generate the precoding matrix (W), the UE may use a codebook based on the coherency indication. In some of these embodiments, to generate the precoding matrix (W), the UE may use a first codebook when the fully coherent codebook type is indicated, may use a second codebook when the non-coherent codebook type is indicated, and may use a third or fourth codebook when the partially coherent codebook type is indicated. In some embodiments, a restriction on codebook parameters may be applied for the fully coherent codebook type. In some embodiments, These embodiments as well as others are described in more detail below.

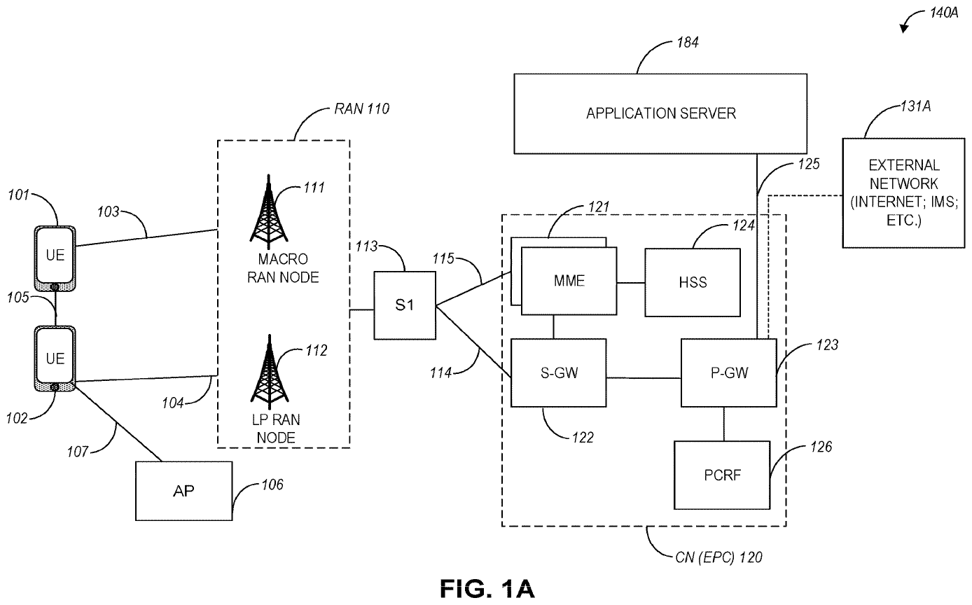

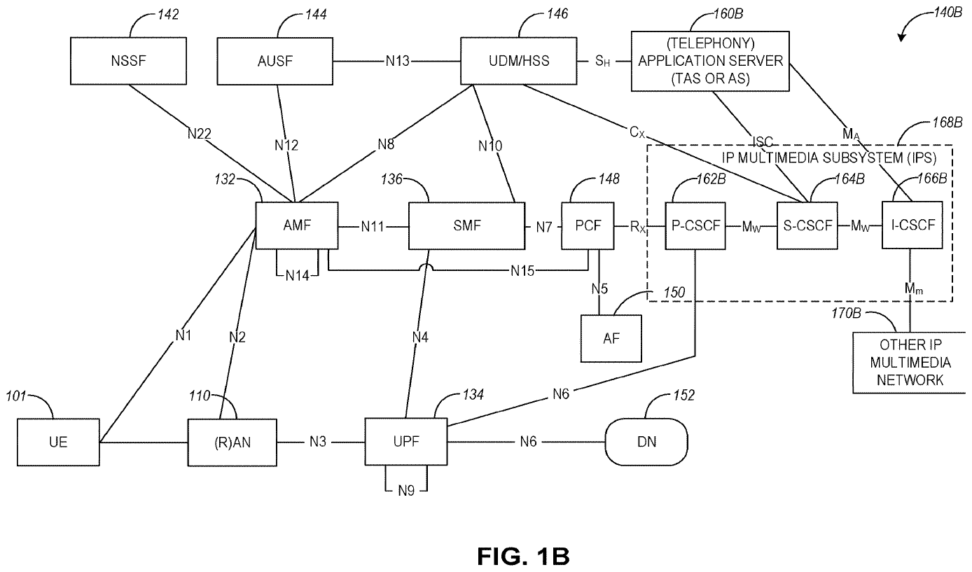

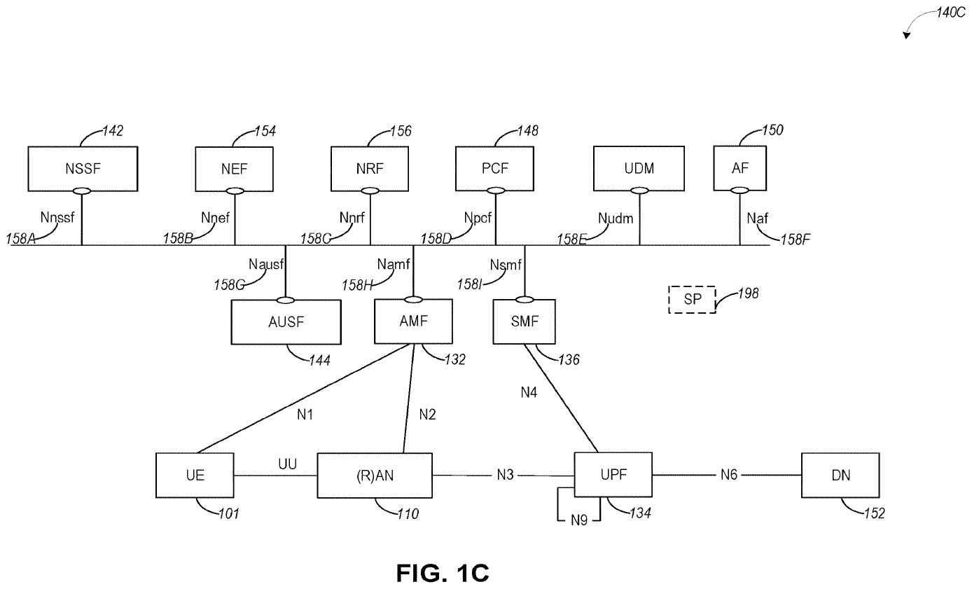

FIG. 1A illustrates an architecture of a network in accordance with some embodiments. The network 140A is shown to include user equipment (UE) 101 and UE 102. The UE 101 and UE 102 are illustrated as smartphones (e.g., handheld touchscreen mobile computing devices connectable to one or more cellular networks) but may also include any mobile or non-mobile computing device, such as Personal Data Assistants (PDAs), pagers, laptop computers, desktop computers, wireless handsets, drones, or any other computing device including a wired and/or wireless communications interface. The UE 101 and UE 102 can be collectively referred to herein as UE 101, and UE 101 can be used to perform one or more of the techniques disclosed herein.

Any of the radio links described herein (e.g., as used in the network 140A or any other illustrated network) may operate according to any exemplary radio communication technology and/or standard.

LTE and LTE-Advanced are standards for wireless communications of high-speed data for UE such as mobile telephones. In LTE-Advanced and various wireless systems, carrier aggregation is a technology according to which multiple carrier signals operating on different frequencies may be used to carry communications for a single UE, thus increasing the bandwidth available to a single device. In some embodiments, carrier aggregation may be used where one or more component carriers operate on unlicensed frequencies.

Embodiments described herein can be used in the context of any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and further frequencies and Spectrum Access System (SAS) in 3.55-3.7 GHZ and further frequencies).

Embodiments described herein can also be applied to different Single Carrier or OFDM flavors (CP-OFDM, SC-FDMA, SC-OFDM, filter bank-based multicarrier (FBMC), OFDMA, etc.) and in particular 3GPP NR (New Radio) by allocating the OFDM carrier data bit vectors to the corresponding symbol resources.

In some embodiments, any of the UE 101 and UE 102 can comprise an Internet-of-Things (IOT) UE or a Cellular IoT (CIOT) UE, which can comprise a network access layer designed for low-power IoT applications utilizing short-lived UE connections. In some embodiments, any of the UE 101 and UE 102 can include a narrowband (NB) IoT UE (e.g., such as an enhanced NB-IOT (eNB-IOT) UE and Further Enhanced (FeNB-IOT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data.

An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

In some embodiments, any of the UE 101 and UE 102 can include enhanced MTC (eMTC) UEs or further enhanced MTC (FeMTC) UEs.

The UE 101 and UE 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN. The UE 101 and UE 102 utilize connections 103 and 104, respectively, each of which comprises a physical communications interface or layer (discussed in further detail below); in this example, the connections 103 and 104 are illustrated as an air interface to enable communicative coupling and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth-generation (5G) protocol, a New Radio (NR) protocol, and the like.

In an aspect, the UE 101 and UE 102 may further directly exchange communication data via a ProSe interface 105. The ProSe interface 105 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi) router. In this example, the AP 106 is shown to be connected to the Internet without connecting to the core network of the wireless system (described in further detail below).

The RAN 110 can include one or more access nodes that enable the connections 103 and 104. These access nodes (ANs) can be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some embodiments, the RAN nodes 111 and 112 can be transmission/reception points (TRPs). In instances when the RAN nodes 111 and 112 are NodeBs (e.g., eNBs or gNBs), one or more TRPs can function within the communication cell of the NodeBs. The RAN 110 may include one or more RAN nodes for providing macrocells, e.g., macro-RAN node, and one or more RAN nodes for providing femtocells or picocells (e.g., cells having smaller coverage areas, smaller user capacity, or higher bandwidth compared to macrocells), e.g., low power (LP) RAN node.

Any of the RAN nodes 111 and 112 can terminate the air interface protocol and can be the first point of contact for the UE 101 and UE 102. In some embodiments, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the RAN nodes 111 and/or 112 can be a new generation Node-B (gNB), an evolved node-B (eNB), or another type of RAN node.

The RAN 110 is shown to be communicatively coupled to a core network (CN) 120 via an S1 interface 113. In embodiments, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility embodiments in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the core network 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VOIP) sessions, PTT sessions, group communication sessions, social networking services, etc.) for the UE 101 and UE 102 via the CN 120.

The P-GW 123 may further be a node for policy enforcement and charging data collection. Policy and Charging Rules Function (PCRF) 126 is the policy and charging control element of the CN 120. In a non-roaming scenario, in some embodiments, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some embodiments, the communication network 140A can be an IoT network or a 5G network, including 5G new radio network using communications in the licensed (5G NR) and the unlicensed (5G NR-U) spectrum. One of the current enablers of IoT is the narrowband-IoT (NB-IoT).

An NG system architecture can include the RAN 110 and a 5G network core (5GC) 120. In these embodiments, the RAN 110 can include a plurality of nodes, such as gNBs and NG-eNBs. The core network 120 (e.g., a 5G core network or 5GC) can include an access and mobility function (AMF) and/or a user plane function (UPF). The AMF and the UPF can be communicatively coupled to the gNBs and the NG-eNBs via NG interfaces. More specifically, in some embodiments, the gNBs and the NG-eNBs can be connected to the AMF by NG-C interfaces, and to the UPF by NG-U interfaces. The gNBs and the NG-eNBs can be coupled to each other via Xn interfaces.

In some embodiments, the NG system architecture can use reference points between various nodes as provided by 3GPP Technical Specification (TS) 23.501 (e.g., V15.4.0, 2018-12). In some embodiments, each of the gNBs and the NG-eNBs can be implemented as a base station, a mobile edge server, a small cell, a home eNB, and so forth. In some embodiments, a gNB can be a master node (MN) and NG-eNB can be a secondary node (SN) in a 5G architecture.

FIG. 1B illustrates a non-roaming 5G system architecture in accordance with some embodiments. Referring to FIG. 1B, there is illustrated a 5G system architecture 140B in a reference point representation. More specifically, UE 102 can be in communication with RAN 110 as well as one or more other 5G core (5GC) network entities. The 5G system architecture 140B includes a plurality of network functions (NFs), such as access and mobility management function (AMF) 132, session management function (SMF) 136, policy control function (PCF) 148, application function (AF) 150, user plane function (UPF) 134, network slice selection function (NSSF) 142, authentication server function (AUSF) 144, and unified data management (UDM)/home subscriber server (HSS) 146. The UPF 134 can provide a connection to a data network (DN) 152, which can include, for example, operator services, Internet access, or third-party services. The AMF 132 can be used to manage access control and mobility and can also include network slice selection functionality. The SMF 136 can be configured to set up and manage various sessions according to network policy. The UPF 134 can be deployed in one or more configurations according to the desired service type. The PCF 148 can be configured to provide a policy framework using network slicing, mobility management, and roaming (similar to PCRF in a 4G communication system). The UDM can be configured to store subscriber profiles and data (similar to an HSS in a 4G communication system).

In some embodiments, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B.

The P-CSCF 162B can be configured to be the first contact point for the UE 102 within the IM subsystem (IMS) 168B. The S-CSCF 164B can be configured to handle the session states in the network, and the E-CSCF can be configured to handle certain embodiments of emergency sessions such as routing an emergency request to the correct emergency center or PSAP. The I-CSCF 166B can be configured to function as the contact point within an operator's network for all IMS connections destined to a subscriber of that network operator, or a roaming subscriber currently located within that network operator's service area. In some embodiments, the I-CSCF 166B can be connected to another IP multimedia network 170E, e.g. an IMS operated by a different network operator.

In some embodiments, the UDM/HSS 146 can be coupled to an application server 160E, which can include a telephony application server (TAS) or another application server (AS). The AS 160B can be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM/HSS 146 and the AMF 132, not shown), N9 (between two UPFs 134, not shown), N10 (between the UDM/HSS 146 and the SMF 136, not shown), N11 (between the AMF 132 and the SMF 136, not shown), N12 (between the AUSF 144 and the AMF 132, not shown), N13 (between the AUSF 144 and the UDM/HSS 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some embodiments, 5G system architectures can be service-based and interaction between network functions can be represented by corresponding point-to-point reference points Ni or as service-based interfaces.

In some embodiments, as illustrated in FIG. 1C, service-based representations can be used to represent network functions within the control plane that enable other authorized network functions to access their services. In this regard, 5G system architecture 140C can include the following service-based interfaces: Namf 158H (a service-based interface exhibited by the AMF 132), Nsmf 158I (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM/HSS 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

In some embodiments, any of the UEs or base stations described in connection with FIGS. 1A-1C can be configured to perform the functionalities described herein.

Mobile communication has evolved significantly from early voice systems to today's highly sophisticated integrated communication platform. The next generation wireless communication system, 5G, or new radio (NR) will provide access to information and sharing of data anywhere, anytime by various users and applications. NR is expected to be a unified network/system that targets to meet vastly different and sometimes conflicting performance dimensions and services. Such diverse multi-dimensional requirements are driven by different services and applications. In general, NR will evolve based on 3GPP LTE-Advanced with additional potential new Radio Access Technologies (RATs) to enrich people's lives with better, simple, and seamless wireless connectivity solutions. NR will enable everything connected by wireless and deliver fast, rich content and services.

Rel-15 NR systems are designed to operate on the licensed spectrum. The NR-unlicensed (NR-U), a short-hand notation of the NR-based access to unlicensed spectrum, is a technology that enables the operation of NR systems on the unlicensed spectrum.

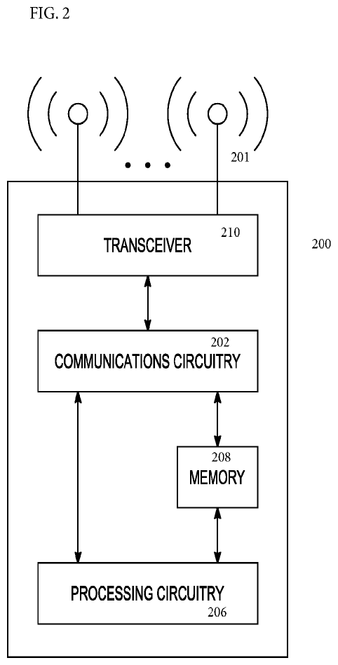

FIG. 2 illustrates a functional block diagram of a wireless communication device, in accordance with some embodiments. Wireless communication device 200 may be suitable for use as a UE or gNB configured for operation in a 5G NR or 6G network. Some embodiments are directed to an apparatus of a UE or gNB comprising processing circuitry and memory configured for operation in a 5G NR or 6G network. The wireless communication device 200 may include communications circuitry 202 and a transceiver 210 for transmitting and receiving signals to and from other communication devices using one or more antennas 201. The communications circuitry 202 may include circuitry that can operate the physical layer (PHY) communications and/or medium access control (MAC) communications for controlling access to the wireless medium, and/or any other communications layers for transmitting and receiving signals. The wireless communication device 200 may also include processing circuitry 206 and memory 208 arranged to perform the operations described herein. In some embodiments, the communications circuitry 202 and the processing circuitry 206 may be configured to perform operations detailed in the above figures, diagrams, and flows.

In accordance with some embodiments, the communications circuitry 202 may be arranged to contend for a wireless medium and configure frames or packets for communicating over the wireless medium. The communications circuitry 202 may be arranged to transmit and receive signals.

The communications circuitry 202 may also include circuitry for modulation/demodulation, upconversion/downconversion, filtering, amplification, etc. In some embodiments, the processing circuitry 206 of the wireless communication device 200 may include one or more processors. In other embodiments, two or more antennas 201 may be coupled to the communications circuitry 202 arranged for sending and receiving signals. The memory 208 may store information for configuring the processing circuitry 206 to perform operations for configuring and transmitting message frames and performing the various operations described herein. The memory 208 may include any type of memory, including non-transitory memory, for storing information in a form readable by a machine (e.g., a computer). For example, the memory 208 may include a computer-readable storage device, read-only memory (ROM), random-access memory (RAM), magnetic disk storage media, optical storage media, flash-memory devices and other storage devices and media.

In some embodiments, the wireless communication device 200 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the wireless communication device 200 may include one or more antennas 201. The antennas 201 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting device.

In some embodiments, the wireless communication device 200 may include one or more of a keyboard, a display, a non-volatile memory port, multiple antennas, a graphics processor, an application processor, speakers, and other mobile device elements. The display may be an LCD screen including a touch screen.

Although the wireless communication device 200 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the wireless communication device 200 may refer to one or more processes operating on one or more processing elements.

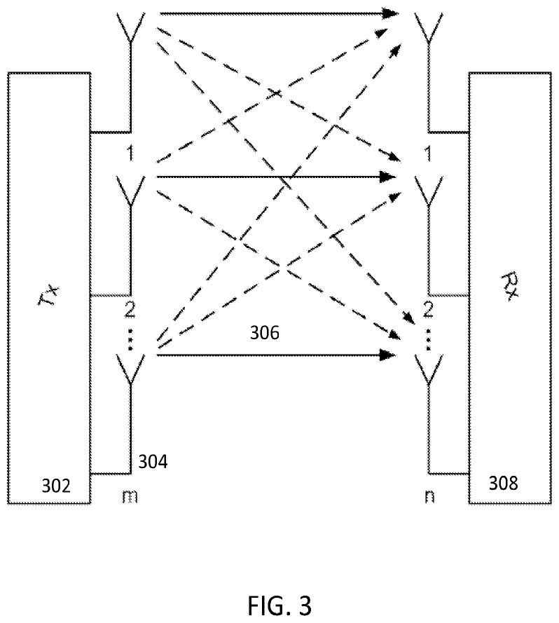

FIG. 3 illustrates a multi-antenna port transmission with multiple transmission layers, in accordance with some embodiments. The multi-antenna port transmission may be a codebook-based PUSCH transmission with the eight antenna ports and up to eight transmission layers. In these embodiments, a UE may decode a radio-resource control (RRC) information element (IE) received from a gNode B (gNB) to configure the UE with a codebook type for a codebook-based physical uplink shared channel (PUSCH) transmission with eight antenna ports and up to eight transmission layers. In these embodiments, the codebook type may have a coherency indication which may indicate one of a fully coherent codebook type, a partially coherent codebook type and a non-coherent codebook type. In these embodiments, the UE may decode a downlink control information (DCI) format scheduling the codebook-based PUSCH transmission with the eight antenna ports. In these embodiments, the DCI format may indicate a transmit precoding matrix indicator (TPMI) index and a number of transmission layers for the PUSCH transmission. The UE may generate a precoding matrix (W) based on the TPMI index and the codebook type and encode a PUSCH for the codebook-based PUSCH transmission with the eight antenna ports and the indicated number of transmission layers by applying the generated precoding matrix. In these embodiments, to generate the precoding matrix (W), the UE may use a codebook based on the coherency indication. In some of these embodiments, to generate the precoding matrix (W), the UE may use a first codebook when the fully coherent codebook type is indicated, may use a second codebook when the non-coherent codebook type is indicated, and may use a third or fourth codebook when the partially coherent codebook type is indicated. These embodiments as well as others are described in more detail below.

As illustrated in FIG. 3, UE 302 operating as a transmitter (TX) may encode a PUSCH for a codebook-based PUSCH transmission 306 with the eight antenna ports 304 (m=8) and the indicated number of transmission layers by applying the generated precoding matrix. Antenna ports 304 are logical entities distinguished by their reference signal sequences and do not necessarily correspond to physical antennas. One or more gNBs, illustrated by reference number 308 operating a receiver RX may decode the codebook-based PUSCH transmission 306 with a number of antennas or antenna ports which may be at least as many as the number of transmission layers used by the UE for transmission of the codebook-based PUSCH transmission 306.

In the third generation partnership project (3GPP) new radio (NR) release-15 (Rel-15)/release-16 (Rel-16)/release-17 (Rel-17) specifications, for uplink transmission, up to 4 transmit (Tx) ports or transmitters may be supported for transmitted the physical uplink shared channel (PUSCH). For codebook based PUSCH transmission, the transmit precoding matrix indicator (TPMI) field in downlink control indication (DCI) may indicate the precoder used for PUSCH transmission. A codebook subset may be configured for the user equipment (UE), including one or more of a fullyAndPartialAndNonCoherent codebook subset, a partialAndNonCoherent codebook subset, and/or a nonCoherent codebook subset.

However, the 3GPP release-18(Rel-18 ) specifications may support up to 8 Tx ports/antennas supported for PUSCH transmission.

In Rel-18, the full coherent precoders may be based on a Rel-15 downlink (DL) Type I codebook. The partial coherent/non-coherent precoder may be based on a Rel-15 4 Tx/2 Tx precoding matrix. Therefore, in Rel-18, the TPMI indication may be enhanced considering or based on the codebook subset configuration. Embodiments herein relate to TPMI indication for PUSCH with 8 Tx considering codebook subset configuration.

### Enhanced TPMI Indication for PUSCH Transmission With 8 Tx

In an embodiment, for UE with 8-Tx, the fullyAndPartialAndNonCoherent codebook subset may include one or more of full coherent precoders, partial coherent precoders, and/or non-coherent precoders. The partialAndNonCoherent codebook subset may contain one or more of partial coherent precoders and non-coherent precoders. The nonCoherent codebook subset may contain non-coherent precoders.

In another embodiment, in the DCI scheduling PUSCH, the DCI may also indicate whether full coherent precoders, partial coherent precoders, and/or non-coherent precoders are indicated in the TPMI field(s) in the DCI, i.e., the precoder coherence could be indicated via DCI.

In one option, the precoder coherence indication could be via a new DCI field. For example, it could be a 2-bit or 1-bit field, binary encoding or bitmap, etc. Alternatively, one or more pre-existing DCI field(s) could be re-used or some special code point(s) of some DCI field(s) could be used for the precoder coherence indication.

In another option, the precoder coherence indication could be via medium access control (MAC)-control element (CE) or configured by radio resource control (RRC) signaling.

In another embodiment, when the fullyAndPartialAndNonCoherent codebook subset is configured, the precoder coherence indication could indicate whether full coherent precoders, partial coherent precoders, and/or non-coherent precoders are indicated in the TPMI field(s) in the DCI. In one example, the precoder coherence indication field could be 2-bit. In one option, one TPMI field could be configured in the DCI.

When the precoder coherence indication indicates full coherent precoder, the TPMI field could indicate the full coherent precoder with 8-port (e.g., with 8 TX ports), which may be based on a DL Type I codebook. In another example, one of or several of or all of the parameters (i.e., i_{1,1}, i_{1,2}, i_{1,3,} and i₂) to generate the 8-port full coherent precoder may be indicated in the DCI.

When the precoder coherence indication indicates partial coherent precoder, the TPMI field may indicate one of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A single 4 Tx precoding matrix to construction the 8-port partial coherent precoder. (e.g., the single 4 Tx precoding matrix may be applied for the partial coherent UE with two antenna groups).
A single 2 Tx precoding matrix to construct the 8-port partial coherent precoder. (e.g., the single 2 Tx precoding matrix may be applied for the partial coherent UE with four antenna groups)
Up to four 2 Tx precoding matrices may be indicated to construct the 8-port partial coherent precoder. (e.g., it/they may be applied for the partial coherent UE with four antenna groups)

When the precoder coherence indication indicates non-coherent precoder, the TPMI field may indicate one or more of the following (although, it will be noted, that the following are intended as illustrative examples, and the TPMI field may additionally or alternatively indicate other information):
One 8-port non-coherent precoder.
Two 4 Tx precoding matrices or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder

The TPMI field size may be determined by the maximum bit width required for one or more of full coherent precoders, partial coherent precoders, and/or non-coherent precoders. For example, X-bits are required for full coherent precoders, Y-bits are required for partial coherent precoders and Z-bits are required for non-coherent precoders. Then the TPMI field length is max {X, Y, Z}.

In one option, the same or different encoding scheme between rank indicator and precoder indicator could be applied for different coherence.

For example, for full coherent precoder, separate encoding of rank indicator and precoder indicator is applied. For partial coherent precoder and/or non-coherent precoder, joint encoding of rank indicator and precoder indicator is applied. The rank indication field should be present in DCI and it should be ignored when partial coherent/non-coherent precoder is indicated.

In another example, joint encoding of rank indicator and precoder indicator could be applied for all the three coherence types. Alternatively, separate encoding of rank indicator and precoder indicator could be applied for all the three coherence types.

In another embodiment, when the fullyAndPartialAndNonCoherent codebook subset is configured, the precoder coherence indication could indicate whether full coherent precoders are indicated in the TPMI field(s) in the DCI, or partial coherent precoders plus non-coherent precoders are indicated in the TPMI field(s) in the DCI. In one example, the precoder coherence indication field could be 1-bit.

In one option, one TPMI field could be configured in the DCI.

When the precoder coherence indication indicates full coherent precoder, the TPMI field could indicate the full coherent precoder with 8-port, which is based on DL Type I codebook. In another example, one of or several of or all of the parameters (i.e., i_{1,1}, i_{1,2}, i_{1,3,} and i₂) to generate the 8-port full coherent precoder are indicated in the DCI.

When the precoder coherence indication indicates partial coherent and non-coherent precoder, the TPMI field could indicate one of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
Only one 4 Tx precoding matrix to construction the 8-port partial coherent precoder. (It could be applied for the partial coherent UE with two antenna groups)
Only one 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder.

The TPMI field size could be determined by the maximum bit width required for full coherent precoders, partial coherent precoders and non-coherent precoders. For example, X-bits are required for full coherent precoders, Y-bits are required for partial coherent precoders and non-coherent precoders.

Then the TPMI field length is max {X, Y}.

In one option, the same or different encoding scheme between rank indicator and precoder indicator could be applied for different coherence.

For example, for full coherent precoder, separate encoding of rank indicator and precoder indicator is applied. For partial coherent precoder and non-coherent precoder, joint encoding of rank indicator and precoder indicator is applied. The rank indication field should be present in DCI and it should be ignored when partial coherent/non-coherent precoder is indicated.

In another example, joint encoding of rank indicator and precoder indicator could be applied for all the three coherence types. Alternatively, separate encoding of rank indicator and precoder indicator could be applied for all the three coherence types.

In another embodiment, when the fullyAndPartialAndNonCoherent codebook subset is configured, up to two or up to four TPMI fields could be included in the DCI. When the precoder coherence indication indicates full coherent precoder, one TPMI field is used. When the precoder coherence indication indicates partial coherent and/or non-coherent precoder, up to two or up to four TPMI fields are used.

In another embodiment, when the partialAndNonCoherent codebook subset is configured, the precoder coherence indication could indicate whether partial coherent precoders or non-coherent precoders are indicated in the TPMI field(s) in the DCI. In one example, the precoder coherence indication field could be 1-bit. In one option, one TPMI field could be configured in the DCI.

When the precoder coherence indication indicates partial coherent precoder, the TPMI field may indicate one or more of the following (although, it will be noted, that the following are intended as illustrative examples, and the TPMI field may additionally or alternatively indicate other information):
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A single 4 Tx precoding matrix to construction the 8-port partial coherent precoder. (e.g., it may be applied for the partial coherent UE with two antenna groups)
A single 2 Tx precoding matrix to construct the 8-port partial coherent precoder. (e.g., it may be applied for the partial coherent UE with four antenna groups)
Up to four 2 Tx precoding matrix are indicated to construct the 8-port partial coherent precoder. (e.g., it/they may be applied for the partial coherent UE with four antenna groups)

When the precoder coherence indication indicates non-coherent precoder, the TPMI field may indicate one of the following: one or more of the following (although, it will be noted, that the following are intended as illustrative examples, and the TPMI field may additionally or alternatively indicate other information):
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder The TPMI field size could be determined by the maximum bit width required for partial coherent precoders and non-coherent precoders. For example, Y-bits are required for partial coherent precoders and Z-bits are required for non-coherent precoders. Then the TPMI field length may be max {Y, Z}. In the second option, in the DCI, up to two TPMI fields could be configured.

When the precoder coherence indication indicates partial coherent precoder, the two TPMI fields could indicate one of the following (it could be applied for the partial coherent UE with two antenna groups and four antenna groups):
One TPMI field indicates one 4 Tx precoding matrix, and another TPMI field indicates one 4 Tx precoding matrix to construct the 8-port partial coherent precoder. Alternatively, only one TPMI field is used to indicate one 4 Tx precoding matrix to construct the 8-port partial coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port partial coherent precoder.
One TPMI field indicates up to two 2 Tx precoding matrix. Up to four 2 Tx precoding matrix are indicated to construct the 8-port partial coherent precoder. (It could be applied for the partial coherent UE with four antenna groups).

When the precoder coherence indication indicates non-coherent precoder, the two TPMI fields could indicate one of the following:
One TPMI field indicates one 4 Tx precoding matrix, and another TPMI field indicates one 4 Tx precoding matrix to construct the 8-port non-coherent precoder. Alternatively, only one TPMI field is used to indicate one 4 Tx precoding matrix to construct the 8-port non-coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port non-coherent precoder.
One TPMI filed indicates up to two 2 Tx precoding matrix, and another TPMI field indicates up to two 2 Tx precoding matrix to construct the 8-port non-coherent precoder.

In the third option, in the DCI, up to four TPMI fields could be configured.

When the precoder coherence indication indicates partial coherent precoder, the four TPMI fields could indicate (it could be applied for the partial coherent UE with four antenna groups): One TPMI field indicates one 2 Tx precoding matrix. Up to four 2 Tx precoding matrix are used to construct the 8-port partial coherent precoder.

When the precoder coherence indication indicates non-coherent precoder, the four TPMI fields could indicate: One TPMI field indicates one 2 Tx precoding matrix. Up to four 2 Tx precoding matrix are used to construct the 8-port non-coherent precoder.

In another option, the same or different encoding scheme between rank indicator and precoder indicator could be applied for different coherence.

In another embodiment, the partialAndNonCoherent codebook subset contains partial coherent precoders and non-coherent precoders. When the partialAndNonCoherent codebook subset is configured, the precoder coherence indication field could be absent in DCI.

In one option, one TPMI field could be configured in the DCI to indicate one or more of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A single 4 Tx precoding matrix to construction the 8-port partial coherent precoder. (It could be applied for the partial coherent UE with two antenna groups)
A single 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It/they could be applied for the partial coherent UE with four antenna groups)
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port partial non-coherent precoder.
Up to four 2 Tx precoding matrix to construct the 8-port non-coherent precoder

In the second option, in the DCI, up to two TPMI fields could be configured to indicate one of the following:
One TPMI field indicates one 4 Tx precoding matrix, and another TPMI field indicates one 4 Tx precoding matrix to construct the 8-port partial coherent precoder. Alternatively, only one TPMI field is used to indicate one 4 Tx precoding matrix to construct the 8-port partial coherent precoder, and another TPMI field is not used. The un-used TPMI field could be absent in DCI or it could be present in DCI but ignored by the UE. (It could be applied for the partial coherent UE with two antenna groups and four antenna groups).
One TPMI field indicates one 2 Tx precoding matrix, and another TPMI field indicates one 4 Tx precoding matrix to construct the 8-port partial coherent precoder. (It could be applied for the partial coherent UE with two antenna groups and four antenna groups).
One TPMI field indicates up to two 2 Tx precoding matrix. Up to four 2 Tx precoding matrix are indicated to construct the 8-port partial coherent precoder. (It could be applied for the partial coherent UE with four antenna groups).
One TPMI field indicates one 4 Tx precoding matrix, and another TPMI field indicates one 4 Tx precoding matrix to construct the 8-port non-coherent precoder. Alternatively, only one TPMI field is used to indicate one 4 Tx precoding matrix to construct the 8-port non-coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port non-coherent precoder.
One TPMI filed indicates up to two 2 Tx precoding matrix, and another TPMI field indicates up to two 2 Tx precoding matrix to construct the 8-port non-coherent precoder.

In the third option, in the DCI, up to four TPMI fields could be configured to indicate one of the following:
One TPMI field indicates one 2 Tx precoding matrix. Up to four 2 Tx precoding matrix are used to construct the 8-port partial coherent precoder. (It could be applied for the partial coherent UE with four antenna groups).
One TPMI field indicates one 2 Tx precoding matrix. Up to four 2 Tx precoding matrix are used to construct the 8-port non-coherent precoder.

In another embodiment, when the nonCoherent codebook subset is configured, the non-coherent precoders are indicated in the TPMI field(s) in the DCI. In one example, the precoder coherence indication field may be absent in the DCI.

In one option, one TPMI field may be configured in the DCI. The TPMI field could indicate one of the following:
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder

The TPMI field size could be determined by the bit width required for non-coherent precoders. For example, Z-bits are required for non-coherent precoders. Then the TPMI field length is Z.

In the second option, in the DCI, up to two TPMI fields could be configured to indicate one of the following:
One TPMI field indicates one 4 Tx precoding matrix, and another TPMI field indicates one 4 Tx precoding matrix to construct the 8-port non-coherent precoder. Alternatively, only one TPMI field is used to indicate one 4 Tx precoding matrix to construct the 8-port non-coherent precoder, and another TPMI field is not used. The un-used TPMI field could be absent in DCI or it could be present in DCI but ignored by the UE.

One TPMI field indicates one 2 Tx precoding matrix, and another TPMI field indicates one 4 Tx precoding matrix to construct the 8-port non-coherent precoder.

One TPMI filed indicates up to two 2 Tx precoding matrix, and another TPMI field indicates up to two 2 Tx precoding matrix to construct the 8-port non-coherent precoder.

In the third option, in the DCI, up to four TPMI fields could be configured to indicate: One TPMI field indicates one 2 Tx precoding matrix. Up to four 2 Tx precoding matrix are used to construct the 8-port non-coherent precoder.

In another embodiment, the precoder coherence could be updated by MAC-CE or configured by RRC. When the precoder coherence of full coherent precoder is indicated by MAC-CE or RRC, then in the DCI, one TPMI field could be configured to indicate the 8-port full coherent precoder. In another example, one of or several of or all of the parameters (i.e., i_{1,1}, i_{1,2}, i_{1,3}, and i₂) to generate the 8-port full coherent precoder are indicated in the DCI.

When the precoder coherence of partial coherent precoder is indicated by MAC-CE or RRC, then in one option, in the DCI, one TPMI field may be configured to indicate one of the following (it could be applied for the partial coherent UE with two antenna groups and four antenna groups):
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A single 4 Tx precoding matrix to construction the 8-port partial coherent precoder. (It could be applied for the partial coherent UE with two antenna groups)
A single 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)

In another option, in the DCI, up to two TPMI fields may indicate one of the following (it could be applied for the partial coherent UE with two antenna groups and four antenna groups):
One TPMI field indicates one 4 Tx precoding matrix, and another TPMI field indicates one 4 Tx precoding matrix to construct the 8-port partial coherent precoder. Alternatively, only one TPMI field is used to indicate one 4 Tx precoding matrix to construct the 8-port partial coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port partial coherent precoder.
One TPMI field indicates up to two 2 Tx precoding matrix. Up to four 2 Tx precoding matrix are indicated to construct the 8-port partial coherent precoder. (It could be applied for the partial coherent UE with four antenna groups).

In another option, in the DCI, up to four TPMI fields could be configured to indicate (it could be applied for the partial coherent UE with four antenna groups): One TPMI field indicates one 2 Tx precoding matrix. Up to four 2 Tx precoding matrix are used to construct the 8-port partial coherent precoder.

When the precoder coherence of non-coherent precoder is indicated by MAC-CE or RRC, then in one option, in the DCI, one TPMI field may indicate one or more of the following (although, it will be noted, that the following are intended as illustrative examples, and the TPMI field may additionally or alternatively indicate other information):
One 8-port non-coherent precoder
One 4 Tx precoding matrix or two 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder

In another option, in the DCI, up to two TPMI fields may indicate one or more of the following (although, it will be noted, that the following are intended as illustrative examples, and the TPMI field may additionally or alternatively indicate other information):
One TPMI field indicates one 4 Tx precoding matrix, and another TPMI field indicates one 4 Tx precoding matrix to construct the 8-port non-coherent precoder. Alternatively, only one TPMI field is used to indicate one 4 Tx precoding matrix to construct the 8-port non-coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port non-coherent precoder.
One TPMI filed indicates up to two 2 Tx precoding matrix, and another TPMI field indicates up to two 2 Tx precoding matrix to construct the 8-port non-coherent precoder.

In another option, in the DCI, up to four TPMI fields could be configured to indicate: One TPMI field indicates one 2 Tx precoding matrix. Up to four 2 Tx precoding matrix are used to construct the 8-port non-coherent precoder.

In another embodiment, if the precoder coherence could be updated by MAC-CE or configured by RRC, then the same or different encoding scheme between rank indicator and precoder indicator could be applied for different coherence. For example, if the full coherent precoder is configured, separate encoding of rank indicator and precoder indicator is applied and the DCI field for rank indication should be present in the DCI. If partial coherent precoder or non-coherent precoder is configured, joint encoding of rank indicator and precoder indicator is applied and the rank indication field is not present in DCI.

In another example, joint encoding of rank indicator and precoder indicator could be applied for all the three coherence types. Alternatively, separate encoding of rank indicator and precoder indicator could be applied for all the three coherence types.

In another embodiment, for UE with 8-Tx, the fullyAndPartialAndNonCoherent codebook subset only contains full coherent precoders. The partialAndNonCoherent codebook subset only contains partial coherent precoders (alternatively, the partialAndNonCoherent codebook subset contains partial coherent precoders and non-coherent precoders). The nonCoherent codebook subset contains non-coherent precoders.

When the fullyAndPartialAndNonCoherent codebook subset is configured, then in the DCI, one TPMI field could be configured to indicate the 8-port full coherent precoder. In another example, one of or several of or all of the parameters (i.e., i_{1,1}, i_{1,2}, i_{1,3}, and i₂) to generate the 8-port full coherent precoder are indicated in the DCI.

When the partialAndNonCoherent codebook subset is configured, then in one option, in the DCI, one TPMI field may indicate one or more of the following (although, it will be noted, that the following are intended as illustrative examples, and the TPMI field may additionally or alternatively indicate other information):
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A single 4 Tx precoding matrix to construction the 8-port partial coherent precoder. (It could be applied for the partial coherent UE with two antenna groups)
A single 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)

In another option, in the DCI, up to two TPMI fields may indicate one of the following (it could be applied for the partial coherent UE with two antenna groups and four antenna groups): one or more of the following (although, it will be noted, that the following are intended as illustrative examples, and the TPMI field may additionally or alternatively indicate other information):
One TPMI field indicates one 4 Tx precoding matrix, and another TPMI field indicates one 4 Tx precoding matrix to construct the 8-port partial coherent precoder. Alternatively, only one TPMI field is used to indicate one 4 Tx precoding matrix to construct the 8-port partial coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port partial coherent precoder.
One TPMI field indicates up to two 2 Tx precoding matrix. Up to four 2 Tx precoding matrix are indicated to construct the 8-port partial coherent precoder. (It could be applied for the partial coherent UE with four antenna groups).

In another option, in the DCI, up to four TPMI fields could be configured to indicate (it could be applied for the partial coherent UE with four antenna groups): One TPMI field indicates one 2 Tx precoding matrix. Up to four 2 Tx precoding matrix are used to construct the 8-port partial coherent precoder.

When the nonCoherent codebook subset is configured, then in one option, in the DCI, one TPMI field may indicate one or more of the following (although, it will be noted, that the following are intended as illustrative examples, and the TPMI field may additionally or alternatively indicate other information):
One 8-port non-coherent precoder
One 4 Tx precoding matrix or two 4 Tx precoding matrix to construct the 8-port non-coherent precoder.
One 2 Tx precoding matrix and one 4 Tx precoding matrix to construct the 8-port non-coherent precoder.

In another option, in the DCI, up to two TPMI fields may indicate one or more of the following (although, it will be noted, that the following are intended as illustrative examples, and the TPMI field may additionally or alternatively indicate other information):
One TPMI field indicates one 4 Tx precoding matrix, and another TPMI field indicates one 4 Tx precoding matrix to construct the 8-port non-coherent precoder. Alternatively, only one TPMI field is used to indicate one 4 Tx precoding matrix to construct the 8-port non-coherent precoder, and another TPMI field is not used. The un-used TPMI field could be absent in DCI or it could be present in DCI but ignored by the UE.
One TPMI field indicates one 2 Tx precoding matrix, and another TPMI field indicates one 4 Tx precoding matrix to construct the 8-port non-coherent precoder.
One TPMI filed indicates up to two 2 Tx precoding matrix, and another TPMI field indicates up to two 2 Tx precoding matrix to construct the 8-port non-coherent precoder.

In another option, in the DCI, up to four TPMI fields could be configured to indicate: One TPMI field indicates one 2 Tx precoding matrix. Up to four 2 Tx precoding matrix are used to construct the 8-port non-coherent precoder.

In another embodiment, for UE with 8-Tx, the fullyAndPartialAndNonCoherent codebook subset only contains full coherent precoders. The partialAndNonCoherent codebook subset only contains partial coherent precoders (alternatively, the partialAndNonCoherent codebook subset contains partial coherent precoders and non-coherent precoders). The nonCoherent codebook subset contains non-coherent precoders.

In this case, the same or different encoding scheme between rank indicator and precoder indicator could be applied for fullyAndPartialAndNonCoherent codebook subset, partialAndNonCoherent codebook subset and nonCoherent codebook subset. For example, for fullyAndPartialAndNonCoherent codebook subset, separate encoding of rank indicator and precoder indicator is applied. For partialAndNonCoherent codebook subset and nonCoherent codebook subset, joint encoding of rank indicator and precoder indicator is applied. In this case, when fullyAndPartialAndNonCoherent codebook subset is configured, the DCI field for rank indication should be present in the DCI. When partialAndNonCoherent codebook subset or nonCoherent codebook subset is configured, the rank indication field is not present in DCI.

In another example, joint encoding of rank indicator and precoder indicator could be applied for all the three codebook subsets. Alternatively, separate encoding of rank indicator and precoder indicator could be applied for all the three codebook subsets.

In another embodiment, for partial coherent precoder and/or non-coherent precoder indication, separate encoding or joint encoding between rank indicator and precoder indicator could be applied in the DCI scheduling PUSCH.

In the first option of the embodiment, separate encoding of rank indicator and precoder indicator is applied.

In the first example of the first option, one DCI field is used for the rank indicator and the precoder indicator, e.g., the TPMI field. Some bits of the DCI field could be used for rank indication, and some other bits could be used for precoder indication. For example, the one DCI field, e.g., TPMI field, could be split into two parts. One part, e.g., the first part, is used for rank indication, and the other part, e.g., the second part, could be used for precoder indication. The bit length of the first part for rank indication could be fixed length, or it could be pre-determined by the maximum number of layers or determined by the configured rank restriction.

Further, the second part of the DCI field could indicate one or more of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A singular 4 Tx precoding matrix to construction the 8-port partial coherent precoder. (It could be applied for the partial coherent UE with two antenna groups)
A singular 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder.

In the second example of the first option, separate DCI field are used for the rank indicator and the precoder indicator. For example, one DCI field, e.g., the TPMI field, is used for the precoder indicator, and another DCI field (it could be newly added) is used for rank indicator. The DCI field for rank indication could be fixed length, or the bit length of the rank indication field could be pre-determined by the maximum number of layers or determined by the configured rank restriction.

Further, the DCI field for precoder indication, e.g., the TPMI field, could indicate one or more of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A singular 4 Tx precoding matrix to construction the 8-port partial coherent precoder. (It could be applied for the partial coherent UE with two antenna groups)
A singular 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder.

In the third example of the first option, separate DCI field are used for the rank indicator and the precoder indicator. For example, one DCI field or multiple DCI fields (e.g., one TPMI field or multiple TPMI fields) are used for the precoder indicator, and another DCI field (it could be newly added) is used for rank indicator. The DCI field for rank indication could be fixed length, or the bit length of the rank indication field could be pre-determined by the maximum number of layers or determined by the configured rank restriction.

Further, in the DCI, up to two TPMI fields could be included to indicate up to two 4 Tx precoding matrix (one TPMI field indicate one 4 Tx precoder, or each TPMI field indicate up to two 2 Tx precoding matrix, or one TPMI field indicate 2 Tx precoder and another TPMI field indicate 4 Tx precoder). Or up to four TPMI fields could be included to indicate up to four 2 Tx precoding matrix (one TPMI field indicate one 2 Tx precoder).

In the second option of the embodiment, joint encoding of rank indicator and precoder indicator is applied.

In the first example of the second option, one TPMI field is included, and it could indicate one of the following:
One 8-port partial coherent precoder
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.
A singular 4 Tx precoding matrix to construction the 8-port partial coherent precoder. (It could be applied for the partial coherent UE with two antenna groups)
A singular 2 Tx precoding matrix to construct the 8-port partial coherent precoder. (It could be applied for the partial coherent UE with four antenna groups)
Up to four 2 Tx precoding matrix are indicated to construct the 8-port partial coherent precoder. (It could be applied for the partial coherent UE with four antenna groups)
One 8-port non-coherent precoder.
Two 4 Tx precoding matrix or one 4 Tx precoding matrix to construct the 8-port non-coherent precoder.
One 2 Tx precoding matrix and one 4 Tx precoding matrix to construct the 8-port non-coherent precoder.
Up to four 2 Tx precoding matrix to construct the 8-port non-coherent precoder.

In the second example of the second option, one DCI field or multiple DCI fields (e.g., one TPMI field or multiple TPMI fields) are contained in the DCI.

Further, in the DCI, up to two TPMI fields could be included to indicate up to two 4 Tx precoding matrix (one TPMI field indicate one 4 Tx precoder, or each TPMI field indicate up to two 2 Tx precoding matrix, or one TPMI field indicate 2 Tx precoder and another TPMI field indicate 4 Tx precoder), and each field could be jointly encoded between the 4 Tx precoder and the rank. Or up to four TPMI fields could be included to indicate up to four 2 Tx precoding matrix (one TPMI field indicate one 2 Tx precoder), and each field could be jointly encoded between the 2 Tx precoder and the rank. In this embodiment, the partial coherent precoder and/or non-coherent precoder could be contained in the codebook subset as described in all the above embodiments in this invention.

Note: Various of the embodiments and/or options described herein may be applied, either jointly or separately, for the case of joint encoding of rank indicator and precoder indicator in DCI, and the case of separate encoding of rank indicator and precoder indicator in DCI.

In the third generation partnership project (3GPP) new radio (NR) Release-15/Release-16/Release-17 (Rel-15/Rel-16/Rel-17) specifications, for uplink transmission, up to 4 layers can be supported for the physical uplink shared channel (PUSCH). In the 3 GPP Release-18(Rel-18 ) specifications, up to 8 layers may be supported for PUSCH transmission. Therefore, it may be desirable to enhance the related uplink precoders to support up to 8 layers with 8 ports.

In Rel-18, the full coherent precoders used for transmission may be based on the Rel-15 downlink (DL) Type I codebook. For Rel-15 DL Type I codebook, it is based on the antenna structure and configuration, such as (N₁, N₂), and (O₁,O₂), where ML. Na are the number of antenna elements in horizontal and vertical direction, respectively, and O₁,O₂ are the oversampling factor in horizontal and vertical direction, respectively. For Type I codebook, the precoder could be generated according to the rank value and parameter i_{1,1}, i_{1,2}, i_{1,3}, and i₂. However, the amount of full coherent precoders based on Type I codebook may be large. There may be low overhead schemes to reduce the amount of precoders, for example, some restrictions may be introduced for the Type I codebook parameters.

As noted, legacy specifications may only support up to 4 layers and up to 4 ports for PUSCH transmission. Embodiments herein relate to restrictions on Type I codebook parameters to reduce the amount of full coherent precoders.

### Configuration and Indication of Full Coherent Precoders With 8 Ports

In an embodiment, for 8-port full coherent precoders which are based on the DL Type I codebook, restriction may be introduced on the parameters to generate the precoders, i.e., i_{1,1}, i_{1,2}, i_{1,3}, and i₂. With restrictions, only a subset of the values for are allowed/used for full coherent precoder generation.

In one example, for i_{1,1} and i_{1,2}, the even number of values could be selected, e.g., {0,2 . . . }. Alternatively, the odd number of values could be selected, e.g., {1,3 . . . }. The same or different subset could be selected for i_{1,1} and i_{1,2}.

In one example, for z, one value (e.g., {0}) or two values (e.g.,) could be selected for Rank-1. One value (e.g., {0} or {1}) could be selected for Rank-2 to Rank-8.

In one example, the value of i_{1,3} could be fixed to 0.

In another embodiment, the restriction on one or several or all the parameters, i_{1,1}, i_{1,2}, i_{1,3}, and i₂ may be configured or updated by higher level signaling such as radio resource control (RRC) or medium access control-control elements (MAC-CE) or indicated by downlink control information (DCI). The restriction indicates which values are allowed. The restriction could be a bitmap.

In another option, the restriction on one or several or all the parameters, i_{1,1}, i_{1,2}, i_{1,3}, and i₂ could be pre-defined in the physical layer-related 3GPP specifications.

In one example, the same restriction may be applied for i_{1,1} and i_{1,2}. Alternatively, different restrictions may be applied for i_{1,1} and i_{1,2}.

In another example, one bitmap may be configured/defined for each parameter. Alternatively, one bitmap could be configured/defined for multiple parameters.

In another embodiment, the restriction on one or several or all the parameters, i_{1,1}, i_{1,2}, i_{1,3}, and i₂ may be configured or pre-defined per rank. The restriction may be the same or different for different ranks.

In another option, the restriction on one or several or all the parameters, i_{1,1}, i_{1,2}, i_{1,3}, and i₂ may be configured or pre-defined across multiple ranks. The restriction may be the same across the ranks.

In another embodiment, the value of oversampling factor for 8-port full coherent precoder, i.e., (O₁, O₂)=(1,1) or (2,1) or (2,2), may be configured/updated/indicated by RRC, configured/updated/indicated by MAC-CE, indicated by DCI, or pre-defined in physical layer spec.

In another embodiment, rank restriction may be introduced for 8-port UE to disable some rank values for transmission. The rank restriction may be configured by RRC or MAC-CE, and the rank restriction may be a bitmap.

In another option, the minimum number of layers and the maximum number of layers may be configured. The rank values between the minimum number of layers and the maximum number of layers may be allowed.

In another embodiment, linear indexing could be defined for the 8-port full coherent precoders.

In one example, the linear index may be defined as below.

FC-TPMI=index(i2)+size(i2)*index(i11,i12)+size(i2)*size(i11,i12)*index(ri), where index(i2) takes values from 0,1, . . . , size(i2)-1, index(i11, i12) takes values from 0,1, . . . , size(i11, i12)−1. size(i 2) is the number of unrestricted i2 entries corresponding to the rank given by index(ri). size(i11,i12) is the number of unrestricted i11 and i12 entries corresponding to the rank given by index(ri).

If separate encoding of rank indicator and precoder indicator is applied, then the linear index for rank-(ri) could be defined as:

FC-TPMI=index(i2)+size(i2)*index(i11,i12)

In another embodiment, in DCI scheduling PUSCH, the 8-port full coherent precoder could be indicated or the parameters to generate the 8-port full coherent precoder are indicated.

In one option, the 8-port full coherent precoder may be indicated. The indication may be via one TPMI field to indicate the index of the 8-port full coherent precoder.

In another option, the parameters to generate the 8-port full coherent precoder, i.e., one or several or all the parameters i_{1,1}, i_{1,2}, i_{1,3}, and i₂, may be indicated. The indication may be via one DCI field (e.g., one TPMI field, the field could be split into multiple parts and one part for each parameter) or via separate DCI fields (e.g., one field for each parameter). If there is only one value used for a certain parameter (e.g., only one used value is configured by higher layer signaling such as RRC/MAC-CE, or pre-defined), then the bit length for the corresponding parameter is zero, i.e., not present in the DCI. For example, if the value of i_{1,3} is set to 0, then the bit length for i_{1,3} is zero.

In one example, the bit length for the parameters, i_{1,1}, i_{1,2}, i_{1,3}, and i₂, could depend on the value range of the parameters and the configured/pre-defined restrictions for the parameters. In another example, the bit length for the parameters, i_{1,1}, i_{1,2}, i_{1,3}, and i₂, is fixed, i.e., it doesn't change with the restrictions.

Note: Various of the above-described embodiments may be applied for the case of joint encoding of rank indicator and precoder indicator in DCI, and/or the case of separate encoding of rank indicator and precoder indicator in DCI.

In another embodiment, in DCI scheduling PUSCH, separate encoding of rank indicator and precoder indicator may be applied.

In a first option, one DCI field may be used for the rank indicator and the precoder indicator, e.g., the TPMI field. Some bits of the DCI field could be used for rank indication, and some other bits could be used for precoder indication.

In one example of the first option, the one DCI field, e.g., the TPMI field, may be split into two parts. One part, e.g., the first part, is used for rank indication, and the other part, e.g., the second part, could be used for precoder indication. The bit length of the first part for rank indication could be fixed length, or it could be pre-determined by the maximum number of layers or determined by the configured rank restriction.

Further, the second part of the DCI field could indicate the 8-port full coherent precoder, and it could indicate the index of the 8-port full coherent precoder.

Alternatively, the second part of the DCI field may indicate the parameters to generate the 8-port full coherent precoder, i.e., i.e., one or several or all the parameters i_{1,1}, i_{1,2}, i_{1,3}, and i₂, are indicated. The bit length for the parameters, i_{1,1}, i_{1,2}, i_{1,3}, and fz, could depend on the value range of the parameters and the configured/pre-defined restrictions for the parameters. If there is only one value used for a certain parameter (e.g., only one used value may be configured by RRC/MAC-CE or pre-defined), then the bit length for the corresponding parameter is zero, i.e., not present in the DCI. In another example, the bit length for the parameters, i_{1,1}, i_{1,2}, i_{1,3}, and i₂, is fixed, i.e., it doesn't change with the restrictions.

In a second option, separate DCI field are used for the rank indicator and the precoder indicator. For example, one DCI field, e.g., the TPMI field, is used for the precoder indicator, and another DCI field (it could be newly added) is used for rank indicator.

In one example of the second option, the DCI field for rank indication could be fixed length, or the bit length of the rank indication field could be pre-determined by the maximum number of layers or determined by the configured rank restriction.

Further, the DCI field for precoder indication, e.g., the TPMI field, could indicate the 8-port full coherent precoder, and it could indicate the index of the 8-port full coherent precoder.

Alternatively, the DCI field for precoder indication, e.g., the TPMI field, could indicate the parameters to generate the 8-port full coherent precoder, i.e., i.e., one or several or all the parameters i_{1,1}, i_{1,2}, i_{1,3}, and i₂, are indicated. The bit length for the parameters, i_{1,1}, i_{1,2}, i_{1,3}, and i₂, could depend on the value range of the parameters and the configured/pre-defined restrictions for the parameters. If there is only one value is used for certain parameter (the only one used value could be configured by RRC/MAC-CE or pre-defined), then the bit length for the corresponding parameter is zero, i.e., not present in the DCI. In another example, the bit length for the parameters, i_{1,1}, i_{1,2}, i_{1,3}, and, is fixed, i.e., it doesn't change with the restrictions.

In a third option, separate DCI fields may be used for the rank indicator and the precoder indicator. For example, one DCI field (e.g., a DCI field introduced to the 3GPP specifications) may be used for rank indicator.

Additionally or alternatively several DCI fields (e.g., newly-introduced DCI fields) may be used to indicate the parameters to generate the 8-port full coherent precoder, i.e., i.e., one or several or all the parameters i_{1,1}, i_{1,2}, i_{1,3}, and i₂, are indicated. In one example, each parameter may correspond to one field. The bit length for each field corresponding to the parameters, i_{1,1}, i_{1,2}, i_{1,3}, and i₂, may depend on the value range of the parameters and the configured/pre-defined restrictions for the parameters. If there is only one value used for a certain parameter (e.g., only one value may be configured by RRC/MAC-CE or pre-defined), then the bit length for the corresponding parameter may be zero, i.e., not present in the DCI. In another example, the bit length for each field corresponding to the parameters i_{1,1}, i_{1,2}, i_{1,3}, and i₂, is fixed, i.e., it may not change with the restrictions.

In another embodiment, in DCI scheduling PUSCH, joint encoding of rank indicator and precoder indicator may be applied. The index of the 8-port full coherent precoder may be indicated, e.g., via TPMI field.

In these embodiments, a maximum rank of eights refers to the number of MIMO transmission layers that can be supported.] [In some embodiments, the UE may decode a medium-access control (MAC) control element (MAC-CE) to determine the restriction on the parameters for use in generating the one or more [fully-coherent] precoders. In some embodiments, the restriction on the parameters for use in generating the one or more fully-coherent precoders may be determined from the RRC signalling. [In some embodiments, the coherence may be indicated by coherent (Ng=1), partial coherent (Ng=2, Ng=4) or non-coherent (Ng=8).]

A partial coherent precoder relies on partial knowledge of the channel coherence time when designing the precoder. A non-coherent precoder does not rely on any channel coherence time knowledge when designing the precoder.

Some embodiments are directed to a user equipment (UE) configured for operation in a fifth-generation new radio (5G NR) network. The UE may decode a radio-resource control (RRC) information element (IE) received from a gNode B (gNB) to configure the UE with a codebook type for a codebook-based physical uplink shared channel (PUSCH) transmission with eight antenna ports and up to eight transmission layers. In these embodiments, the codebook type may have a coherency indication which may indicate one of a fully coherent codebook type, a partially coherent codebook type and a non-coherent codebook type.

The UE may decode a downlink control information (DCI) format scheduling the codebook-based PUSCH transmission with the eight antenna ports. In these embodiments, the DCI format may indicate a transmit precoding matrix indicator (TPMI) index and a number of transmission layers for the PUSCH transmission. The UE may generate a precoding matrix (W) based on the TPMI index and the codebook type and encode a PUSCH for the codebook-based PUSCH transmission with the eight antenna ports and the indicated number of transmission layers by applying the generated precoding matrix.

In these embodiments, to generate the precoding matrix (W), the UE may use a codebook based on the coherency indication. In some of these embodiments, to generate the precoding matrix (W), the UE may use a first codebook (codebook1; ng=1) when the fully coherent codebook type is indicated, may use a second codebook (codebook4; ng=8) when the non-coherent codebook type is indicated, and may use a third or fourth codebook (codebook2: ng=2, or codebook3: ng=4) when the partially coherent codebook type is indicated.

In some embodiments, the number of transmission layers corresponds to a maximum rank of eight. In these embodiments, the TPMI index for an eight-port coherent precoder and a rank may be jointly indicated in the DCI format scheduling the codebook-based PUSCH transmission with eight antenna ports. In these embodiments, the codebook type indicates only one codebook type (i.e., either the fully coherent codebook type, the partial codebook type or a non-coherent codebook type).

In some embodiments, when the codebook type indicates the fully coherent codebook type, the processing circuitry may be configured to apply a restriction on parameters for use in generating the precoding matrix (W). In some embodiments, the restriction may limit a number of the fully coherent precoders to be applied to the codebook-based PUSCH transmission. In some embodiments, the restriction on the parameters for use in generating the precoding matrix may be indicated in the DCI format.

In some embodiments, the RRC IE may comprise a PUSCH-Config IE to configure the UE with specific PUSCH parameters applicable to a particular band width part (BWP). In these embodiments, the codebook type may be indicated by the PUSCH-Config IE.

In some embodiments, the restriction on the parameters for use in generating the precoding matrix may be based at least in part on the rank.

In some embodiments, when the codebook type indicates one of the partial coherent codebook type and the non-coherent codebook type, the UE may generate the precoding matrix without the restriction on parameters.

In some embodiments, the UE may encode, for transmission to the gNB, a UE capability information element indicating that the UE is capable of supporting the codebook-based PUSCH transmission with eight antenna ports and up to eight transmission layers. In these embodiments, the UE capability information element may also indicate one of noncoherent, partial coherent, and full coherent for a multiple-input multiple output (MIMO) transmission with a number of supported transmission layers.

In some embodiments, the first codebook (codebook1; ng=1) may be configured for one antenna port group (ng=1), the second codebook (codebook4; ng=8) may be configured for eight antenna port groups (ng=8), the third codebook (codebook2: ng=2) may be configured for two antenna port groups (ng=2), and the fourth codebook (codebook3: ng=4) may be configured for four antenna port groups (ng=4).

In some embodiments, the UE may comprise processing circuitry which may comprises a baseband processor. In some embodiments, the UE may comprise memory configured to store the precoding matrix.

Some embodiments are directed to a computer-readable storage medium that stores instructions for execution by processing circuitry of a user equipment (UE) configured for operation in a fifth-generation new radio (5G NR) network.

Some embodiments are directed to a gNodeB (gNB) configured for operation in a fifth-generation new radio (5G NR) network. In these embodiments, the gNB may encode a radio-resource control (RRC) information element (IE) for transmission to a user equipment (UE) to configure the UE with a codebook type for a codebook-based physical uplink shared channel (PUSCH) transmission with eight antenna ports and up to eight transmission layers. In these embodiments, the codebook type may indicate one of a fully coherent codebook type, a partially coherent codebook type and a non-coherent codebook type. In these embodiments, the gNB may encode a downlink control information (DCI) format for transmission to the UE scheduling the codebook-based PUSCH transmission with the eight antenna ports. The DCI format may indicate a transmit precoding matrix indicator (TPMI) index and a number of transmission layers.

In these embodiments, the gNB may decode a PUSCH comprising the codebook-based PUSCH transmission with the eight antenna ports and the indicated number of transmission layers received from the UE. The codebook-based PUSCH transmission with the eight antenna ports may be based on application of a precoding matrix (W) generated by the UE based on the TPMI index and the codebook type. In some embodiments, a first codebook (codebook 1; ng=1) may be used to generate the precoding matrix (W) when the fully coherent codebook type is indicated, a second codebook (codebook4; ng=8) may be used to generate the precoding matrix (W) when the non-coherent codebook type is indicated, and a third or fourth codebook (codebook2: ng=2, or codebook3: ng=4) may be used to generate the precoding matrix (W) when the partially coherent codebook type is indicated.

### EXAMPLES

Example 1 may include the gNB, wherein the gNB could configure the UE for PUSCH transmission with 8 Tx.

Example 2 may include the method of example 1 or some other example herein, wherein the codebook subset could be configured by the gNB, including fullyAndPartialAndNonCoherent codebook subset, partialAndNonCoherent codebook subset, and nonCoherent codebook subset.

Example 3 may include the method of example 2 or some other example herein, wherein for UE with 8 Tx, the fullyAndPartialAndNonCoherent codebook subset contains full coherent precoders, partial coherent precoders and non-coherent precoders. The partialAndNonCoherent codebook subset contains partial coherent precoders and non-coherent precoders. The nonCoherent codebook subset contains non-coherent precoders.

Example 4 may include the method of example 1 or some other example herein, wherein in the DCI scheduling PUSCH, the DCI can also indicate whether full coherent precoders, or partial coherent precoders or non-coherent precoders are indicated in the TPMI field(s) in the DCI, i.e., the precoder coherence could be indicated via DCI.

Example 5 may include the method of example 4 or some other example herein, wherein the precoder coherence indication could be via a new DCI field. Alternatively, some existing DCI field(s) could be re-used or some special code point(s) of some DCI field(s) could be used for the precoder coherence indication.

Example 6 may include the method of example 1 to example 4 or some other example herein, wherein the precoder coherence indication could be via MAC-CE or configured by RRC signaling

Example 7 may include the method of example 1 to example 6 or some other example herein, wherein when the fullyAndPartialAndNonCoherent codebook subset is configured, the precoder coherence indication could indicate whether full coherent precoders, or partial coherent precoders or non-coherent precoders are indicated in the TPMI field(s) in the DCI. And one TPMI field could be configured in the DCI.

Example 8 may include the method of example 7 or some other example herein, wherein when the precoder coherence indication indicates full coherent precoder, the TPMI field could indicate the full coherent precoder with 8-port, which is based on DL Type I codebook.

Example 9 may include the method of example 7 or some other example herein, wherein when the precoder coherence indication indicates partial coherent precoder, the TPMI field could indicate:
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.

Example 10 may include the method of example 7 or some other example herein, wherein when the precoder coherence indication indicates non-coherent precoder, the TPMI field could indicate:
One 8-port non-coherent precoder.
Two 4 Tx precoding matrix to construct the 8-port non-coherent precoder.
One 2 Tx precoding matrix and one 4 Tx precoding matrix to construct the 8-port partial coherent precoder.

Example 11 may include the method of example 7 or some other example herein, wherein the TPMI field size could be determined by the maximum bit width required for full coherent precoders, partial coherent precoders and non-coherent precoders.

Example 12 may include the method of example 1 to example 6 or some other example herein, wherein when the partialAndNonCoherent codebook subset is configured, the precoder coherence indication could indicate whether partial coherent precoders or non-coherent precoders are indicated in the TPMI field(s) in the DCI. And one TPMI field could be configured in the DCI.

Example 13 may include the method of example 12 or some other example herein, wherein when the precoder coherence indication indicates partial coherent precoder, the TPMI field could indicate:
One 4 Tx precoding matrix or two 4 Tx precoding matrix to construct the 8-port partial coherent precoder.
One 2 Tx precoding matrix and one 4 Tx precoding matrix to construct the 8-port partial coherent precoder.

Example 14 may include the method of example 12 or some other example herein, wherein when the precoder coherence indication indicates non-coherent precoder, the TPMI field could indicate:
One 8-port non-coherent precoder.
Two 4 Tx precoding matrix to construct the 8-port non-coherent precoder.
One 2 Tx precoding matrix and one 4 Tx precoding matrix to construct the 8-port partial coherent precoder.

Example 15 may include the method of example 1 to example 6 or some other example herein, wherein when the nonCoherent codebook subset is configured, the non-coherent precoders are indicated in the TPMI field(s) in the DCI. And one TPMI field could be configured in the DCI.

Example 16 may include the method of example 15 or some other example herein, wherein the TPMI field could indicate:
One 8-port non-coherent precoder.
Two 4 Tx precoding matrix to construct the 8-port non-coherent precoder.
One 2 Tx precoding matrix and one 4 Tx precoding matrix to construct the 8-port partial coherent precoder.

Example 17 may include the method of example 15 or some other example herein, wherein the TPMI field size could be determined by the bit width required for non-coherent precoders.

Example 18 includes a method to be performed by a user equipment (UE), one or more elements of a UE, and/or an electronic device that includes and/or implements a UE, wherein the method comprises:
identifying, from a base station, an indication of a codebook subset related to uplink (UL) transmission with 8 transmit ports; and
transmitting, based on the codebook subset, the UL transmission via the 8 transmit ports.

Example 19 includes the method of example 18, and/or some other example herein, wherein the UL transmission is a UL physical uplink shared channel (PUSCH) transmission.

Example 20 includes the method of any of examples 18-19, and/or some other example herein, wherein the codebook subset is a fullyAndPartialAndNonCoherent codebook subset that includes full coherent precoders, partial coherent precoders, and non-coherent precoders.

Example 21 includes the method of any of example 18-20, and/or some other example herein, wherein the codebook subset is a partialAndNonCoherent codebook subset that includes partial coherent precoders and non-coherent precoders.

Example 22 includes the method of any of examples 18-21, and/or some other example herein, wherein the codebook subset is a nonCoherent code book subset that includes non-coherent precoders.

Example 23 includes the method of any of examples 18-22, and/or some other example herein, wherein the indication of the codebook subset is signaled in downlink control information (DCI).

Example 24 includes the method of any of examples 18-22, and/or some other example herein, wherein the indication of the codebook subset is signaled in radio resource control (RRC) signaling.

Example 25 includes the method of any of examples 18-22, and/or some other example herein, wherein the indication of the codebook subset is signaled in medium access control (MAC)-control element (CE) signaling.

Example 26 includes a method to be performed by a base station, one or more elements of a base station, and/or an electronic device that includes and/or implements a base station, wherein the method comprises:

transmitting, to a user equipment (UE), an indication of a codebook subset related to uplink (UL) transmission with 8 transmit ports; and identifying, from the UE based on the codebook subset, the UL transmission via the 8 transmit ports.

Example 27 includes the method of example 26, and/or some other example herein, wherein the UL transmission is a UL physical uplink shared channel (PUSCH) transmission.

Example 28 includes the method of any of examples 26-27, and/or some other example herein, wherein the codebook subset is a fullyAndPartialAndNonCoherent codebook subset that includes full coherent precoders, partial coherent precoders, and non-coherent precoders.

Example 29 includes the method of any of example 26-28, and/or some other example herein, wherein the codebook subset is a partialAndNonCoherent codebook subset that includes partial coherent precoders and non-coherent precoders.

Example 30 includes the method of any of examples 26-29, and/or some other example herein, wherein the codebook subset is a nonCoherent code book subset that includes non-coherent precoders.

Example 31 includes the method of any of examples 26-30, and/or some other example herein, wherein the indication of the codebook subset is signaled in downlink control information (DCI).

Example 32 includes the method of any of examples 26-30, and/or some other example herein, wherein the indication of the codebook subset is signaled in radio resource control (RRC) signaling.

Example 33 includes the method of any of examples 26-30, and/or some other example herein, wherein the indication of the codebook subset is signaled in medium access control (MAC)-control element (CE) signaling.

### Additional Examples

Example 1 may include the gNB, wherein the gNB could configure the full coherent UE with PUSCH transmission of 8 ports.

Example 2 may include the method of example 1 or some other example herein, wherein the full coherent precoder is based on Rel-15 DL Type I codebook.

Example 3 may include the method of example 1 and example 2 or some other example herein, wherein restriction could be introduced on the parameters to generate the full coherent precoders, i.e., i_{1,1}, i_{1,2}, i_{1,3}, and i₂. With restrictions, only a subset of the values for are allowed/used for full coherent precoder generation.

Example 4 may include the method of example 3 or some other example herein, wherein the restriction on one or several or all the parameters, i_{1,1}, i_{1,2}, i_{1,3}, and i₂ could be configured by RRC or updated by MAC-CE or indicated by DCI. The restriction indicates which values are allowed. The restriction could be a bitmap.

Example 5 may include the method of example 3 or some other example herein, wherein the restriction on one or several or all the parameters, i_{1,1}, i_{1,2}, i_{1,3}, and i₂ could be pre-defined in physical layer spec.

Example 6 may include the method of example 3 or some other example herein, wherein the restriction on one or several or all the parameters, i_{1,1}, i_{1,2}, i_{1,3}, and i₂could be configured or pre-defined per rank. The restriction could be the same or different for different ranks.

Example 7 may include the method of example 3 or some other example herein, wherein the restriction on one or several or all the parameters, i_{1,1}, i_{1,2}, i_{1,3}, and i₂ could be configured or pre-defined across multiple ranks. The restriction could be the same across the ranks.

Example 8 may include the method of example 1 and example 2 or some other example herein, wherein the value of oversampling factor for 8-port full coherent precoder, i.e., (O₁, O₂)=(1,1) or (2,1) or (2,2), could be configured by RRC, or updated by MAC-CE, or indicated by DCI, or pre-defined in physical layer spec.

Example 9 may include the method of example 1 and example 2 or some other example herein, wherein linear indexing could be defined for the 8-port full coherent precoders.

Example 10 may include the method of example 1 and example 2 or some other example herein, wherein in DCI scheduling PUSCH, the 8-port full coherent precoder could be indicated or the parameters to generate the 8-port full coherent precoder are indicated.

Example 11 may include the method of example 10 or some other example herein, wherein the 8-port full coherent precoder is indicated. The indication could be via one TPMI field to indicate the index of the 8-port full coherent precoder.

Example 12 may include the method of example 10 or some other example herein, wherein the parameters to generate the 8-port full coherent precoder, i.e., i_{1,1}, i_{1,2}, i_{1,3}, and i₂, are indicated. The indication could be via one DCI field (e.g., one TPMI field, the field could be split into multiple parts and one part for each parameter) or via separate DCI fields (e.g., one field for each parameter). If there is only one value is used for certain parameter (the only one used value could be configured by RRC/MAC-CE or pre-defined), then the bit length for the corresponding parameter is zero, i.e., not present in the DCI. For example, if the value of i_{1,3} is set to 0, then the bit length for i_{1,3} is zero.

Example 13 may include the method of example 12 or some other example herein, wherein the bit length for the parameters, i_{1,1}, i_{1,2}, i_{1,3}, and i₂, could depend on the value range of the parameters and the configured/pre-defined restrictions for the parameters. Alternatively, the bit length for the parameters, i_{1,1}, i_{1,2}, i_{1,3}, and i₂, is fixed, i.e., it doesn't change with the restrictions.

Example 14 may include the method of example 1 and example 2 or some other example herein, wherein in DCI scheduling PUSCH, separate encoding of rank indicator and precoder indicator could be applied.

Example 15 may include the method of example 14 or some other example herein, wherein one DCI field is used for the rank indicator and the precoder indicator, e.g., the TPMI field. Some part of the DCI field could be used for rank indication, and some other part could be used for precoder indication.

Example 16 may include the method of example 14 or some other example herein, wherein separate DCI field are used for the rank indicator and the precoder indicator. For example, one DCI field, e.g., the TPMI field, is used for the precoder indicator, and another DCI field (it could be newly added) is used for rank indicator.

Example 17 may include the method of example 14 or some other example herein, wherein separate DCI field are used for the rank indicator and the precoder indicator. For example, one DCI field (it could be newly added) is used for rank indicator. Another several DCI fields (could be newly added fields) are used to indicate the parameters to generate the 8-port full coherent precoder, i.e., i.e., one or several or all the parameters i_{1,1}, i_{1,2}, i_{1,3}, and i₂, are indicated.

Example 18 may include the method of example 1 and example 2 or some other example herein, wherein in DCI scheduling PUSCH, joint encoding of rank indicator and precoder indicator could be applied. The index of the 8-port full coherent precoder should be indicated, e.g., via TPMI field.

Example 19 includes a method to be performed by a user equipment (UE), one or more elements of a user equipment (UE), and/or one or more electronic devices that include and/or implement a UE, wherein the method comprises:
identifying that the UE is to transmit a physical uplink shared channel (PUSCH) transmission on more than 4 transmit ports;
generating, based on a restriction related to values to be used for the generation of a full coherent precoder, the full coherent precoder to be used for the PUSCH transmission; and
transmitting, based on the full coherent precoder, the PUSCH transmission on the more than 4 transmit ports.

Example 20 includes the method of example 19 and/or some other example herein, wherein the PUSCH transmission is to be transmitted on 8 transmit ports.

Example 21 includes the method of any of examples 19-20, and/or some other example herein, wherein the full coherent precoder is further generated based on a third generation partnership project (3GPP) release-15 (Rel-15) downlink (DL) Type 1 codebook.

Example 22 includes the method of any of examples 19-21, and/or some other example herein, wherein the restriction relates to a subset of values of the 3 GPP Rel-15 DL Type 1 codebook that may be used for generation of the full coherent precoder.

Example 23 includes the method of any of examples 19-22, and/or some other example herein, wherein the method further comprises identifying the restriction based on radio resource control (RRC) signaling.

Example 24 includes the method of any of examples 19-22, and/or some other example herein, wherein the method further comprises identifying the restriction based on a medium access control-control element (MAC-CE) signal.

Example 25 includes the method of any of examples 19-22, and/or some other example herein, wherein the method further comprises identifying the restriction based on a downlink control information (DCI).

Example 26 includes the method of any of examples 19-22, and/or some other example herein, wherein the method further comprises identifying the restriction based on a bitmap.

Example 27 includes the method of any of examples 19-22, wherein the restriction is pre-configured.

Example 28 includes a method to be performed by a base station, one or more elements of a base station, and/or one or more electronic devices that include and/or implement a base station, wherein the method comprises:
identifying a physical uplink shared channel (PUSCH) transmission that was transmitted from a user equipment (UE) on more than 4 transmit ports, wherein the PUSCH transmission was transmitted based on a full coherent precoder, wherein the full coherent precoder is based on a restriction related to values to be used for the generation of the full coherent precoder; and
processing the PUSCH transmission.

Example 29 includes the method of example 28 and/or some other example herein, wherein the PUSCH transmission was transmitted on 8 transmit ports.

Example 30 includes the method of any of examples 28-29, and/or some other example herein, wherein the full coherent precoder is further based on a third generation partnership project (3GPP) release-15 (Rel-15) downlink (DL) Type 1 codebook.

Example 31 includes the method of any of examples 28-30, and/or some other example herein, wherein the restriction relates to a subset of values of the 3 GPP Rel-15 DL Type 1 codebook that may be used for generation of the full coherent precoder.

Example 32 includes the method of any of examples 28-30, and/or some other example herein, wherein the method further comprises transmitting, to the UE, an indication of the restriction in radio resource control (RRC) signaling.

Example 33 includes the method of any of examples 28-30, and/or some other example herein, wherein the method further comprises transmitting, to the UE, an indication of the restriction in a medium access control-control element (MAC-CE) signal.

Example 34 includes the method of any of examples 28-30, and/or some other example herein, wherein the method further comprises transmitting, to the UE, an indication of the restriction in a downlink control information (DCI).

Example 35 includes the method of any of examples 28-30, and/or some other example herein, wherein the restriction is based on a bitmap.

Example 36 includes the method of any of examples 28-30, wherein the restriction is pre-configured.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a user equipment (UE) configured for operation in a fifth-generation new radio (5G NR) network, the apparatus comprising: processing circuitry; and memory, the processing circuitry is configured to:
decode a radio-resource control (RRC) information element (IE) received from a gNode B (gNB) to configure the UE with a codebook type for a codebook-based physical uplink shared channel (PUSCH) transmission with eight antenna ports and up to eight transmission layers,
the codebook type indicating one of a fully coherent codebook type, a partial codebook type and a non-coherent codebook type;
decode a downlink control information (DCI) format scheduling the codebook-based PUSCH transmission with the eight antenna ports, the DCI format indicating a transmit precoding matrix indicator (TPMI) index and a number of transmission layers;
generate a precoding matrix (W) based on the TPMI index and the codebook type;
encode a PUSCH for the codebook-based PUSCH transmission with the eight antenna ports and the indicated number of transmission layers by applying the generated precoding matrix,
wherein to generate the precoding matrix (W), the processing circuitry is configured to:
use a first codebook when the fully coherent codebook type is indicated;
use a second codebook when the non-coherent codebook type is indicated; and
use a third or fourth codebook when the partial coherent codebook type is indicated.

2. The apparatus of claim 1, wherein the number of transmission layers corresponds to a maximum rank of eight, and
wherein the TPMI index for an eight-port coherent precoder and a rank are jointly indicated in the DCI format scheduling the codebook-based PUSCH transmission with eight antenna ports.

3. The apparatus of claim 2, wherein when the codebook type indicates the fully coherent codebook type, the processing circuitry is configured to apply a restriction on parameters for use in generating the precoding matrix (W), the restriction limiting a number of the fully coherent precoders to be applied to the codebook-based PUSCH transmission.

4. The apparatus of claim 3, wherein the restriction on the parameters for use in generating the precoding matrix is indicated in the DCI format.

5. The apparatus of claim 4, wherein the RRC IE comprises a PUSCH-Config IE to configure the UE with specific PUSCH parameters applicable to a particular band width part (BWP), and
wherein the codebook type is indicated by the PUSCH-Config IE.

6. The apparatus of claim 5, wherein the restriction on the parameters for use in generating the precoding matrix is based at least in part on the rank.

7. The apparatus of claim 6, wherein when the codebook type indicates one of the partial coherent codebook type and the non-coherent codebook type, the processing circuitry is configured to generate the precoding matrix without the restriction on parameters.

8. The apparatus of claim 3, wherein the processing circuitry is configured to encode, for transmission to the gNB, a UE capability information element indicating that the UE is capable of supporting the codebook-based PUSCH transmission with eight antenna ports and up to eight transmission layers, the UE capability information element further indicating one of noncoherent, partial coherent, and full coherent for a multiple-input multiple output (MIMO) transmission with a number of supported transmission layers.

9. The apparatus of claim 3, wherein the first codebook is configured for one antenna port group, the second codebook is configured for eight antenna port groups, the third codebook is configured for two antenna port groups, and the fourth codebook is configured for four antenna port groups.

10. The apparatus of claim 1, wherein the processing circuitry comprises a baseband processor; and wherein the memory is configured to store the precoding matrix.

11. A computer-readable storage medium that stores instructions for execution by processing circuitry of a user equipment (UE) configured for operation in a fifth-generation new radio (5G NR) network, the processing circuitry is configured to:
decode a radio-resource control (RRC) information element (IE) received from a gNode B (gNB) to configure the UE with a codebook type for a codebook-based physical uplink shared channel (PUSCH) transmission with eight antenna ports and up to eight transmission layers,
the codebook type indicating one of a fully coherent codebook type, a partial coherent codebook type and a non-coherent codebook type;
decode a downlink control information (DCI) format scheduling the codebook-based PUSCH transmission with the eight antenna ports, the DCI format indicating a transmit precoding matrix indicator (TPMI) index and a number of transmission layers;
generate a precoding matrix (W) based on the TPMI index and the codebook type;
encode a PUSCH for the codebook-based PUSCH transmission with the eight antenna ports and the indicated number of transmission layers by applying the generated precoding matrix,
wherein to generate the precoding matrix (W), the processing circuitry is configured to:
use a first codebook when the fully coherent codebook type is indicated;
use a second codebook when the non-coherent codebook type is indicated; and
use a third or fourth codebook when the partial coherent codebook type is indicated.

12. The computer-readable storage medium of claim 11, wherein the number of transmission layers corresponds to a maximum rank of eight, and
wherein the TPMI index for an eight-port coherent precoder and a rank are jointly indicated in the DCI format scheduling the codebook-based PUSCH transmission with eight antenna ports.

13. The computer-readable storage medium of claim 12, wherein when the codebook type indicates the fully coherent codebook type, the processing circuitry is configured to apply a restriction on parameters for use in generating the precoding matrix (W), the restriction limiting a number of the fully coherent precoders to be applied to the codebook-based PUSCH transmission.

14. The computer-readable storage medium of claim 13, wherein the restriction on the parameters for use in generating the precoding matrix is indicated in the DCI format.

15. The computer-readable storage medium of claim 14, wherein the RRC IE comprises a PUSCH-Config IE to configure the UE with specific PUSCH parameters applicable to a particular band width part (BWP), and
wherein the codebook type is indicated by the PUSCH-Config IE.

16. The computer-readable storage medium of claim 15, wherein the restriction on the parameters for use in generating the precoding matrix is based at least in part on the rank.

17. The computer-readable storage medium of claim 16, wherein when the codebook type indicates one of the partial coherent codebook type and the non-coherent codebook type, the processing circuitry is configured to generate the precoding matrix without the restriction on parameters.

18. The computer-readable storage medium of claim 13, wherein the processing circuitry is configured to encode, for transmission to the gNB, a UE capability information element indicating that the UE is capable of supporting the codebook-based PUSCH transmission with eight antenna ports and up to eight transmission layers, the UE capability information element further indicating one of noncoherent, partial coherent, and full coherent for a multiple-input multiple output (MIMO) transmission with a number of supported transmission layers.

19. An apparatus for a gNodeB (gNB) configured for operation in a fifth-generation new radio (5G NR) network, the apparatus comprising: processing circuitry; and memory, the processing circuitry is configured to:
encode a radio-resource control (RRC) information element (IE) for transmission to a user equipment (UE) to configure the UE with a codebook type for a codebook-based physical uplink shared channel (PUSCH) transmission with eight antenna ports and up to eight transmission layers,
the codebook type indicating one of a fully coherent codebook type, a partial coherent codebook type and a non-coherent codebook type;
encode a downlink control information (DCI) format for transmission to the UE scheduling the codebook-based PUSCH transmission with the eight antenna ports, the DCI format indicating a transmit precoding matrix indicator (TPMI) index and a number of transmission layers;
decode a PUSCH comprising the codebook-based PUSCH transmission with the eight antenna ports and the indicated number of transmission layers received from the UE, the codebook-based PUSCH transmission with the eight antenna ports based on application of a precoding matrix (W) generated by the UE based on the TPMI index and the codebook type,
wherein:
a first codebook is used to generate the precoding matrix (W) when the fully coherent codebook type is indicated;
a second codebook is used to generate the precoding matrix (W) when the non-coherent codebook type is indicated; and
a third or fourth codebook is used to generate the precoding matrix (W) when the partial coherent codebook type is indicated.

20. The apparatus of claim 19, wherein the number of transmission layers corresponds to a maximum rank of eight, and
wherein the TPMI index for an eight-port coherent precoder and a rank are jointly indicated in the DCI format scheduling the codebook-based PUSCH transmission with eight antenna ports.
